(19) United States
(12) Patent Application Publication
(10) Pub. No.: US 2003/0037151 A1
(43) Pub. Date: Feb. 20, 2003

(54) Method of handling utilization conflicts in digital networks

(76) Inventors: Andras Montvay, Aachen (DE); Heribert Baldus, Aachen (DE); Markus Baumeister, Aachen (DE)

Correspondence Address: U.S. Philips Corporation, 580 White Plains Road, Tarrytown, NY, 10591, US

(21) Appl. No.: 10/217,809

(22) Filed: Aug. 12, 2002

(30) Foreign Application Priority Data
Aug. 16, 2001 (DE) 10140149.3

(51) Int. Cl. G06F 15/16

(52) U.S. Cl. 709/229

(57) ABSTRACT

The invention relates to a method of handling utilization conflicts in digital networks, particularly in in-home digital networks. Such a conflict occurs where a second application seeks to access a resource for a second objective, the resource already being used by a first application for a first objective. In such cases the method searches for modifications to the actual requests for network components that will permit achievement of the first objective and the second objective simultaneously. If the first objective, for example, is to provide sports news, and for this purpose the first request seeks to record sports news on a video recorder at a certain time, and a second application requests the video recorder at this time, this conflict may possibly be resolved by recording another program containing sports news at a later time to resolve the first objective. That is to say the actual request for the “video recorder” resource is modified by a deferment, the underlying objective, however, remaining the same.

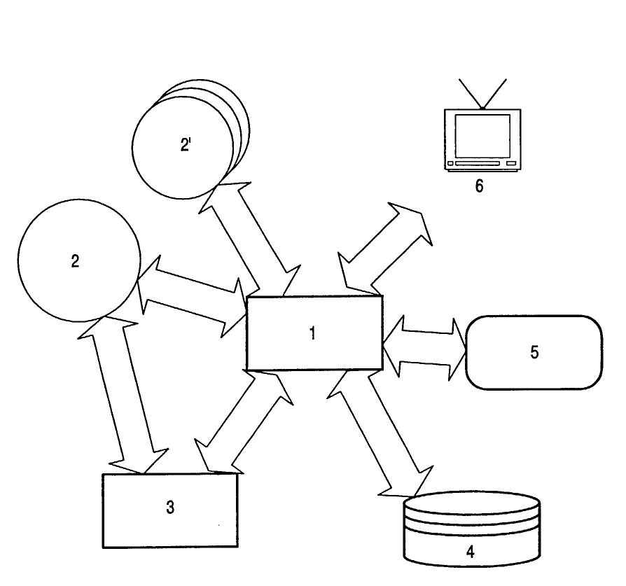

The invention relates to a method of handling utilization conflicts in digital networks, especially in in-home digital networks, where a resource being used by a first application for a first objective is requested by a second application for a second objective. The invention further relates to a digital network, in particular an in-home digital network, in which such a method is implemented.

The processing of information is subject to increasing digitalization and networking of processing media. Where this relates to the home area the associated networks are referred to as in-home digital networks (IHDN). Such IHDN can incorporate televisions, radios, monitors, loudspeakers, cameras, printers, scanners, PCs, telephone services, voice recognition, domestic appliance controls, security devices and the like. In the case of audio and video media, in particular, with their high data rates typically of 100 Mbit/s this often results, however, in utilization conflicts when various applications are competing for resources (both unit and network resources).

Although a number of resource management systems in networks are already known in the state of the art, these are always predicated on at least one of the following assumptions:

A request is regarded as being described entirely by its explicit parameters. That is to say, it is assumed that there is no additional, initially unconsidered, information elsewhere in the system that plays any part in evaluating the request.

If there is any negotiation at all concerning service quality, for example, this takes place between one application and the managing unit, but not at user level.

The request is assumed to be unambiguous-in the sense that although a reduction along a certain parameter axis sometimes makes sense, the fundamental modification of the request to completely different parameter values does not.

The reduction of a request requires the explicit consent of the requesting agency; no “knowledge” exists elsewhere of the preferences and acceptability with regard to certain parameters.

The alternative offers in the course of a negotiation are not matched to the application with the aid of additional information, but are merely inferred generically from the resources available.

A request can also be rejected completely and without alternative offer.

Newly arriving requests are considered in isolation, that is to say there is no renegotiation of old requests (no preemption, if need be through complete cancellation of an old request).

The following applies with regard to some actual examples of resource management systems:

Although the resource management in HAVi 1.0 allows preemption (even by querying the user), this relates to the complete release of a unit in use, i.e. the old request is completely overwritten. None of the existing requests is examined for alternatives; the user does not receive any genuine assistance.

Processor scheduling mechanisms in operating systems and the Internet Differentiated Services Architecture in each case assume request priorities, which are intended to lead to a (more or less) fair allocation of the scarce resource. No reservations of any kind are made here, however, in the sense of a firm assurance.

The Internet Integrated Services Architecture (Resource Reservation Protocol RSVP) simply rejects requests that cannot be fulfilled.

Against this background, it was an object of the present invention to provide a method and a device by means of which utilization conflicts in digital networks, particularly in in-home digital networks can be resolved flexibly and efficiently.

This object is achieved by a method having the features defined in claim 1 and by a digital network having the features defined in claim 10. Advantageous developments are contained in the dependent claims.

The method proposed serves for handling utilization conflicts in digital networks such as, in particular, in-home digital networks, the conflict arising from the situation in which a first application has been using a resource for a first objective and in the meantime this same resource is requested by a second application for a second objective. According to the method, modifications to the request for the resource by the first application and/or the request for the resource by the second application are then sought, the modifications sought being intended to permit simultaneous achievement of both the first objective and the second objective.

In the proposed method, a distinction is therefore made between the actual request for the resource and an underlying objective. This allows the utilization conflict to be resolved through modifications to the requests with simultaneous fulfillment of the objectives, which constitute the criterion actually relevant to the user of the network. The distinction between the actual request for an actual resource and an underlying, more abstract objective affords great flexibility in the search for solutions. Furthermore it is important that modifications are sought both to the request by the later, second application and also to the request by the earlier, first application. Unlike in many other methods, therefore, the first application is not taboo, which opens up a correspondingly greater array of possible solutions.

There are numerous possible ways in which the request for a resource can actually be modified. The modification may consist, in particular, of a complete or partial deferment of the request, of a modification to the access parameters such as, in particular, the band width and/or data rate of the access and/or of a switch to another, equivalent resource. The request for a resource may furthermore also be fundamentally restructured, for example by switching to a resource serving as intermediate station.

The underlying objectives of the respective requests can, in particular, be represented by a data flowchart, which preferably contains information on the requested data and the desired purpose of these data. The requested data may be, for example, certain sports news, a particular film, a certain piece of music or the like. The desired purpose of these data may be defined, for example, by the method of representation (audio/video) and representation parameters (image size, resolution, volume etc.).

According to a development of the method, in the search for modifications to the requests for the resource, account is taken of user profiles. These may be known and explicitly provided data relating to the users of the network. It is equally possible, however, for the data of the user profile to be acquired adaptively through observation of the user behavior. Thus it is possible to determine, for example, which preferences a specific user has for the services available on the network, e.g. whether he uses the Internet frequently or follows certain television programs. Furthermore, the user profile may also include data from the user's diary, which allow a decision to be made on the deferment of access to resources.

In addition, in the search for a resolution of the network conflicts some interaction preferably takes place with the user or users of the network. For this purpose the user may, if necessary, be asked for additional information not already present in the system. Furthermore, it is possible to obtain the consent of the user for a proposed modification to the resource access before implementing the modification identified. If the proposed modification consists in reducing the bandwidth of a video access, for example, the user will be given the opportunity to consent, since he may sometimes not agree to the resulting deterioration in picture quality.

According to another development of the method, an order in which the proposed modifications are advantageously implemented is also determined for an identified conflict resolution. Predefining such an order prevents the applications from undertaking an uncontrolled modification of the access, which might lead, for example, to reciprocal blocking of the access or to unwanted interruption of one of the applications.

The modification can furthermore be suggested by at least one of the objectives, if no suitable modifications to the actual requests for the limited resource were found without changing the objectives. The proposal for modification of the objective can here make use of existing or learned information, especially user profiles. Thus for example, the recording of a comparable news program might be proposed, if the news program originally desired cannot be recorded owing to the resource conflict. The above-mentioned proposal by the system to undertake an audio or video transmission with reduced band width may also be an example of a modification of the underlying objective, if the quality of the transmission was an integral part of the original objective.

In addition, it is also possible to devise proposals for a modification or extension of the network and/or its resources, in order to minimize future utilization conflicts. Such proposals may be based, for example, on the fact that specific types of utilization conflicts are repeatedly observed, which can be avoided by adding a further resource or by restructuring of the network.

Furthermore, the method can be developed in such away that utilization conflicts are handled in anticipation. In particular, the request for the resource by the second application may in this case be merely a predicted request, the prediction being based on learned user profiles, for example. In this case, the subsequent conflict situation to the anticipated as a result of the second request can already be taken into account when executing the first request for the resource and as far as possible resolved or avoided beforehand.

The invention further relates to a digital network, in particular an in-home digital network, which comprises at least one data processing unit, on which an implementation of applications, a resource management system, and a mediator module is undertaken, the mediator module being set up so that it can perform a method of the type explained above. The network furthermore comprises a database, which is linked to the data processing unit and preferably contains information on the topology, the resources and the connection of the network, on data stocks in the network and services available from service providers and broadcasters, on default and/or learned user profiles and user data. Finally the network also has at least one user interface, which is linked to the data processing unit and permits communication with a user.

The invention will be further described with reference to examples of embodiment shown in the drawings, to which, however, the invention is not restricted.

The sole FIGURE shows a diagram of the components of an in-home network according to the invention.

In an in-home digital network (IHDN), an example of which is represented in the FIGURE, various applications are competing for resources (both units and also network resources). A request from a user to perform a particular action can sometimes not be fulfilled using the existing resources. Instead of merely informing the user of a refusal, the system will make suggestions of how a compromise solution can be found by modifying this and other, existing requests, and will then implement these. The motivation for this type of user support lies in the complexity of an IHDN compared to analog A/V systems or also in comparison to an individual PC. In contrast to these systems, the correlations between applications and resources may be unclear to the user, so that he cannot arrive at a solution himself. An example from the analog A/V sphere: if the video recorder VCR is already recording something, and the user wishes to consider another recording, the resource conflict for the VCR deck is obvious and resolvable by the user through compromise (deferment or do without). In the IHDN a similar conflict may be much more subtle and incomprehensible to the user. Thus it may happen, for example, that the differing data rate which results from the Mpeg coding of more or less “action-packed” video sequences has an influence on whether simultaneous pickup of two currents is possible or not. The possible solutions are also rather more complex, such as recording in order to reduce the video bandwidth.

Moreover the networking of all devices in a home also allows the applications of all occupants to compete directly with one another for resources (e.g. network load). Whereas previously the only applications that came into conflict were those intended to run on the same device (e.g. recording and playback of videos), conflicts can now occur between entirely different applications (e.g. Web download vs. video recording), so that the frequency of conflicts between requests from different users increases greatly. Here a user sometimes needs support from the IHDN simply because the other user, whose request is in competition with his own, is not even present, so that the system must serve in an advisory capacity. The ideal solution, for example, would be one that recognizes from the diary of the absent person that the latter can in any case only watch the video, currently being downloaded from the Web, the day after, and thereupon proposes that the download be deferred by a few hours. The object of the system according to the invention, therefore, is never to refuse a request by a user out of hand, but to seek for possible alternatives until a solution acceptable to all users has been found.

This object is achieved by a network having a so-called mediator system, which according to the FIGURE comprises the following components:

a resource management system 3 for managing of the existing resources (bus lines, network nodes, data processing units, input/output units, telephone services etc.);

a mediator 1;

a database 4 with content alternatives, an applications catalog, user preferences and information etc.;

a user interface 6 for the exchange of information with a user;

a central mediation algorithm 5, which is preferably compiled heuristically and, where appropriate, using methods of artificial intelligence;

various applications 2, 2′.

The components listed and represented in the FIGURE exist at least in logical form, but may be variously combined in an actual implementation.

The mediator system may reside as software on an existing unit also used elsewhere (STB, or possibly PC), which must then be continuously available, or be incorporated as a single unit into the network. In the latter case it will possibly store the database 4 on another unit (home archive or the like).

The functional sequence of a mediation is as follows:

The application 2 makes a request to the resource management system 3 which, however, cannot be fulfilled. The application 2 thereupon applies to the mediator 1. In so doing it gives the mediator 1 not only the actual resource request but also a general description of the underlying objective in the form of a desired data flowchart (i.e. a data structure which describes, for example, that a source with the content “CNN” is connected to a sink (display) having specified characteristics such as location, size, video quality etc.).

The mediator 1 obtains further information on the existing conflict from resource management system 3, other applications 2′ affected, the database 4 and the user interface 6. For example, from the resource management 3 it obtains the information as to which application is currently using the resource in question, and from this application the data flowchart currently being implemented with the aid of this resource; from the database 4 it obtains the user profile of both users affected, and from the user interface 6 the value of an adjustment not yet set in the profile. The mediator 1 then passes this information to the mediation algorithm 5.

The mediation algorithm 5 attempts to arrive at an alternative solution. To do this, the mediator 1 may retrieve further information, which was not initially supplied, and which it can again extract from the other aforementioned entities. This is preferably implemented by means of a generally defined descriptive language for the scanning of information. In particular, one of the possible queries addressed to the mediator 1 is that regarding user acceptance for a proposed solution, which is examined by means of the user interface 6.

If the mediation algorithm 5 finds a solution that fulfils all the requirements set, it informs the mediator 1 of this. This communication takes the form, for example of data flowcharts for each application affected, the general requests according to “Source with Content CNN” being replaced, however, by actually named resources. At the same time it is also stated in which order the applications 2, 2′ can switch from the resources currently in use to new resources (migration path), without generating a blockage (in the event of a blockage, application 2 will, according to the solution, acquire resource A, but tries this before the resource according to the solution has been released from application 2′). If there is no simple migration path, the algorithm can also specify a “diversion”, i.e. along the lines “application 2 must first briefly release all resources, since otherwise a circular dependence will exist between multiple applications”. The necessity for such diversions during the migration must obviously, where necessary, be taken into account by the algorithm when evaluating a solution, since such a thing may be unacceptable to the user, for example, where it involves the recording of a broadcast program, in which this would cause an interruption.

The mediator 1 is now responsible for calling on the applications 2, 2′ to modify their use of resources along the specified migration path.

The following modifications to a request are, in principle, feasible in order to reach a suitable compromise:

Deferment of the entire action or parts thereof (particularly of the outstanding part, once a competing request appears).

Slowing down, reduction of the data rate, account being taken of the greater length of time required.

Reduction in the service quality, e.g. the video band width.

Change to another resource, which is also suitable for this request (e.g. switching to another storage medium or other network path).

Restructuring of the application, e.g. despite the request to write to a transportable storage medium, initial storage on a hard disk and subsequent transfer to desired medium.

Modification of the type of data source, e.g. switching to Internet broadcast in the event of conflict over DVB tuner.

Restriction of the request at junctures unimportant to the user (e.g. dispensing with the recording of advertising slots and breaks in a sports transmission, for example, reduction of the data rate in “Anchorman” sequences of news programs).

Change to an alternative content or another application (e.g. where the recording of the Home Archive cannot be played back, since the Home Archive is being used to capacity elsewhere, but the next sequence of the same game show is currently on live on the television, this is offered as alternative).

Combinations of all these and other measures.

In order to decide which of these modifications is feasible, the mediation algorithm uses the following:

Topology and resource information via the IHDN and its connection to access networks (source: resource management 3/database 4);

information on data stocks in the IHDN and services available from service providers/broadcasters (e.g. television program) (source: database 4);

Both explicitly inputted an implicitly emerging user preferences (e.g. where the user's preferences for certain actors, groups etc. have been established by means of a TiVo-like function; “TiVo” is the rating of television programs by means of “Thumbs up”/“Thumbs down” keys on the remote control and evaluation of the correlation between this rating and meta-information on features of the program such as actors, subject matter etc., which is transmitted by the station; this function can also be expanded to include other contents such as web pages and, combined, for example, with length of time spent on a web site etc. as evaluation criterion) (source: database 4);

Interaction with the user, which is feasible not only locally, but possibly also through inquiries via SMS and the like (source: user interface 6);

Other information on the user, e.g. diary (source: database 4)

Information on the current use of occupied resources (source: other applications 2, 2′);

A possible method of identifying an optimum conflict resolution may run as follows:

1. On the existing data flowcharts operations are defined, by means of which a conflict can possibly be remedied. Examples of this are replacement of one node with another (e.g. switch to other), modification of parameters at a node (e.g. reduction of service quality) or to the entire chart (e.g. deferment to later time), or also the insertion of additional parts into the charts (e.g. interim storage of the data on another data carrier).

2. It is defined precisely which parts of the data flowchart are in conflict, that is to say, for example, two requests relate to the unit X over the time interval Y.

3. From the operations that are basically feasible, selection centers on those that have a bearing on the conflict.

4. Each of these operations is classified in a certain category, which describes what the chances are of finding a good compromise by means of this operation, whether another inquiry needs to be addressed to the user etc. Thus, for example, many operations will lead to new conflicts with yet other requests, which then require closer examination. At this stage, use is made solely of the information already available to the algorithm (this may mean, for example, that the use being made of a resource necessary for the operation is unknown, and therefore the operation is classified in the category “further information needed, but might then be a good solution”).

5. In a predetermined sequence (possibly dependent on the user profile), a closer examination is undertaken, category by category, of tentative solutions, until a good proposal is found. To do this, one proposed solution after the other in each category is examined more closely, e.g. by also requesting further information from the mediator. On the basis of this information, either a final evaluation is possible, or the proposed solution migrates into another category of solutions. Solutions from the “most filled” category are processed, until a proposal shifts into the “solves the problem” category.

6. Where necessary, it is also possible to continue searching after an acceptable proposal has been found. This depends, for example, on how long the user is prepared to wait for a solution. It may be that a compromise is initially implemented, in order to be able to search for the optimum solution “in peace”.

In contrast to the existing resource management and scheduling systems, the method outlined takes account of the fact that a resources request on an IHDN only represents an imprecise picture of the actual (much more abstract) desire on the part of the user. The actual desire on the part of the user may be, for example, to be comprehensively informed of the sports news when he returns late in the evening. This first prompts the request by means of the user interface 6 and a corresponding application 2′ (and any coincidences and arbitrary decisions on the part of the systems and the user) to record the sports news from channel X on to the hard disk of the machine A at 20:00. This mapping is by no means unambiguous, however, and its imprecision should be taken into account in the event of a conflict. For the user is sometimes just as happy if the sports news is recorded from channel Y at 21:00 and the special broadcast from the local sports festival on the local station at 21:30, and not on machine A but on machine B, the sections in which only the “anchorman” is on screen being stored with a distinctly reduced picture quality in order to reduce the overall data quantity.

The invention described permits a system that is capable of identifying and using such alternative solutions.

Another advantage of the system is that in the event of a resource conflict the “older” application is not just preferred on principle. Typical existing algorithms for resource management only consider modification of the new, additional request for the resolution of a resource bottleneck. In the event of a conflict emerging, the approach outlined, on the other hand, gives equal consideration to all existing requests and the new request, which widens the scope for a possible solution considerably and leads to better results.

Possible expansions of the method described might be as follows:

The mediator 1 can learn from resolved conflicts. For example, solution categories that have provided good results in the past might be rated more highly, typical conflicts can be classified and provided with a “specimen solution”, etc.

By processing the resultant conflicts, the mediator 1 can, for example, offer suggestions as to what additional hardware the user should procure, how he should reconfigure his IHDN, or what additional services offered by a service provider he should subscribe to.

With TiVo-like functions the mediator 1 can itself start up any applications, in order to anticipate assumed future requests.

The mediator 1 can endeavor to foresee conflicts before they arise and to avoid them or gather necessary additional information (e.g. by asking the user “At the time you wish to record this program, there is a football match on with X's favorite team—he will certainly want to watch that. Is it o.k. if I record the repeat of your program the next day?”) To do this, the mediator 1 can of its own accord invoke the algorithm 5, in order, for example, to keep a desired resource free as a precaution, if that is possible. For this purpose the mediator 1 presents the data flowchart for the application affected and an artificial data flowchart, which consists merely of a request for the desired resource, to the algorithm 5, together with information, that there is no question of a modification of any kind to this chart.

The mediator 1 assumes the role of “scapegoat”, for example by “posting” the user, who was absent when the conflict arose, a “note of apology” on the recording made with reduced service quality, and noting who was dissatisfied with its decisions, in order to take more account of this next time, etc.

1. A method of handling utilization conflicts in digital networks, especially in in-home digital networks, where a resource being used by a first application for a first objective is requested by a second application for a second objective, characterized in that modifications to the requests for the resource by the first application and/or by the second application are sought, which permit achievement of the first objective and of the second objective.

2. A method as claimed in claim 1, characterized in that the modification of a request for the resource consists of
a complete or partial deferment of the request;
a modification of the access parameters, in particular the band width and/or the data rate of the access;
a shift to another, equivalent resource;
a shift to a resource serving as intermediate station.

3. A method as claimed in claim 1 or 2, characterized in that the objectives are represented by a data flowchart, which preferably contains information on the data requested and the desired object of these data.

4. A method as claimed in any one of claims 1 to 3, characterized in that in the search for modifications to the requests, known user profiles and/or ones learned by adaptation are used, which in particular contain information on the diary of the user and/or preferences of the user for certain services available on the network.

5. A method as claimed in any one of claims 1 to 4, characterized in that a user is asked for additional information and/or approval or rejection of the modifications found.

6. A method as claimed in any one of claims 1 to 5, characterized in that an order is also determined for implementation of the modifications found.

7. A method as claimed in any one of claims 1 to 6, characterized in that a modification of at least one objective is proposed, if no modifications to the requests are found without changing the objectives.

8. A method as claimed in any one of claims 1 to 7, characterized in that proposals for a modification of the network and/or its resources are compiled, in order to minimize future utilization conflicts.

9. A method as claimed in any one of claims 1 to 8, characterized in that the request by the second application is merely a predicted request.

10. A digital network, in particular an in-home network, comprising
at least one data processing unit, on which an implementation of applications (2, 2′), a resource management system (3), and a mediator module (1, 5) is running;
a database (4), which is linked to the data processing unit;
at least one user interface (6), which is linked to the data processing unit; the mediator module being set up so that it can perform a method as claimed in any one of claims 1 to 9.
